(19) United States
(12) Patent Application Publication
(10) Pub. No.: US 2022/0048343 A1
(43) Pub. Date: Feb. 17, 2022

(54) You got air!

(71) Applicants: Patricia Annie Thomas, Pine Bluff, AR (US); Terri Gaylor Sizemore, Box Springs, GA (US)

(72) Inventors: Patricia Annie Thomas, Pine Bluff, AR (US); Terri Gaylor Sizemore, Box Springs, GA (US)

(73) Assignees: Patricia Annie Thomas, Pine Bluff, AR (US); Terri Gaylor Sizemore, Box Springs, GA (US)

(21) Appl. No.: 16/873,913

(22) Filed: Aug. 13, 2020

(51) Int. Cl. B60C 29/06; B60S 5/04

(52) U.S. Cl. CPC B60C 29/064; B60S 5/04

(57) ABSTRACT

This air transferring apparatus is a system for conducting air flow which includes the air chuck for receiving or giving air, a crimp attached to the hose to allow the air chuck to remain engaged to the hose, the hose to supply air from one high pressure tire to the low pressure tire, and clamp to be placed on the valve stem to stay engaged with no assistance.

### FIELD

The present application relates to a device that gives one a sense of confidence knowing that having a flat or low tire pressure is no longer a travel issue or an issue with the change of the weather affecting the amount of air pressure in tires.

### BACKGROUND

Throughout time, compressors of some sort have been used to fill air into tires of all types of vehicles. Once air compressors are filled with air, they are used to inflate flat tires or tires with low air pressure. This present application has no need for compressors. This present application also offers a solution to the wait time for assistance with getting your vehicle to a safe space, knowing that having a flat or low tire is no longer an issue. Using this device alleviates the low air pressure problem. It allows one to borrow air from (one or three) inflated tires to inflate the problem tire. Nylon with rubber coating or rubber material works well with this application because of the flexibility, the inexpensive cost, and because it can be crimped. The length of the hose will depend on the vehicle.

### SUMMARY

By providing a device that gives one confidence knowing that having a flat tire or low air pressure is no longer a travel or everyday issue. The advantage of this device is to offer vehicle owners worldwide the opportunity to carry this device in their vehicle to offset the waiting for assistance.

The fitting goes on top of the rubber hose, the connector connects to the valve stem of the tire, and then it crimps together. Both ends are male fittings connected to the ends of the hose. One end would serve as a locking device on the problem tire. The other end would be attached to any (or all three tires) to deflate enough air to inflate the troubled tire.

Previous problems with drivers having a flat tire or low air pressure tire: (1) call family or friends to assist them, (2) call road side assistance, (3) unsafely fix flat tires on the side of the road, or seek help from people you don't know. You Got Air! gives one confidence, knowing they don't have to wait for assistance, which could turn into hours. You simply get out of your vehicle, secure one end of the hose to the problem tire, and borrow air by attaching the other end of the hose to one (or all three tires), to inflate the air into the problem tire, then drive to a safe area to get the tire fixed or changed with a spare tire.

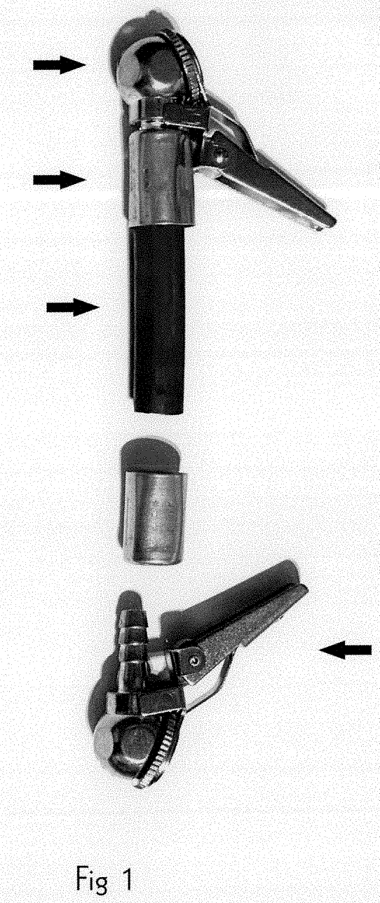

FIG. 1—An air transfer device that is comprised of an air chuck (1) that allows one to receive or give air, a crimp (2) that attaches to the hose and allows air chuck to remain engaged to the hose, a hose (3) that supplies air from one high pressure tire to the low pressure tire, and a clamp (4) that allows one to put the clamp on the valve stem to stay engaged with no assistance.

1. Air transfer device comprising of an air chuck connected to both ends of said hose to attach to tires to share air.
